(19) United States
(12) Patent Application Publication
(10) Pub. No.: US 2024/0389205 A1
(43) Pub. Date: Nov. 21, 2024

(54) FOOD COVER FOR MICROWAVE OVEN

(71) Applicant: FULIANG DAI, RUI'AN (CN)

(72) Inventor: FULIANG DAI, RUI'AN (CN)

(21) Appl. No.: 18/419,656

(22) Filed: Jan. 23, 2024

(30) Foreign Application Priority Data
May 19, 2023 (CN) 202321255161.6

(51) Int. Cl. H05B 6/64; A47J 36/02; A47J 36/06

(52) U.S. Cl. CPC H05B 6/6408; A47J 36/027; A47J 36/06

(57) ABSTRACT

Disclosed is a food cover for a microwave oven. The food cover includes a cover body and a handle on the cover body, where the cover body is provided with a vent hole and divided into a first cover body and a second cover body, and the second cover body is hinged to the first cover body; upper edges, lower edges and surfaces of the first cover body and the second cover body match in shape, such that after the second cover body is turned downwards, the upper edge of the second cover body is attached to the upper edge of the first cover body, and the lower edges of the second cover body and the first cover body are located in the same plane; and after the second cover body is turned upwards, the second cover body and the first cover body are stacked.

### TECHNICAL FIELD

The present disclosure relates to the field of kitchen utensils, in particular to a food cover for a microwave oven.

### BACKGROUND ART

Food is generally covered when heated in a microwave oven in order to prevent oil splash. A common food cover takes up much room and is inconvenient to store due to its raised hemispherical or nearly hemispherical shape. In order to save storage space, a cover is made from a foldable material for some products, for example, a foldable cover for a microwave oven as disclosed in Chinese Patent Publication No. CN307494374S. However, this cover has high requirements for materials for compressibility and foldability. Moreover, this cover cannot be partially opened to check a food state or replace food to be heated. As disclosed in Chinese Patent Publication No. CN112137431A entitled “Split Pot Cover”, a foldable pot cover can be opened to check a food state during use. However, the cover is liftable upwards, and is not conducive to saving of storage space.

### SUMMARY

In order to solve the problems of an existing food cover for a microwave oven, the present disclosure designs a novel food cover for a microwave oven into two parts, which can reduce a size of the cover and save storage space.

In order to achieve the above objective, the present disclosure uses a specific solution as follows:

A food cover for a microwave oven includes a cover body and a handle on the cover body, where the cover body is provided with a vent hole, the cover body is divided into a first cover body and a second cover body, and the second cover body is hinged to the first cover body; upper edges, lower edges and surfaces of the first cover body and the second cover body match in shape, such that after the second cover body is turned downwards, the upper edge of the second cover body is attached to the upper edge of the first cover body, and the lower edge of the second cover body and the lower edge of the first cover body are located in the same plane; and after the second cover body is turned upwards, the second cover body and the first cover body are stacked.

The cover body in the present disclosure may be in any shape as long as the two divided parts of the cover body can be rotated to be stacked together and a size can be reduced. Preferably, the first cover body and the second cover body have cambered surfaces, and the first cover body and the second cover body that is stretched form a hemisphere.

Preferably, a hinge point of the first cover body and the second cover body is at a junction of the upper edge and the lower edge. The hinge point is arranged in such a position, such that the second cover body can be turned over conveniently.

According to the present disclosure, the cover is divided into two parts. In order to collect water or oil flowing down from the two parts of the cover, each of the lower edges of the first cover body and the second cover body is provided with one diversion recess, two ends of the diversion recess are closed, and a diversion nozzle is provided in each of the diversion recesses, and is configured to pour the water/oil out from the diversion recess.

Preferably, one diversion nozzle is provided at each of outer sides of two ends of the diversion recess of each of the first cover body and the second cover body. In this way, collected water or oil can be poured out from two sides without angle adjustment.

The diversion recess may be arranged by bending the cover body as an integral part of the cover body, and or may be separately arranged. Preferably, the diversion recess is a semi-annular recess that matches the lower edges of the first cover body and the second cover body in length, and the diversion recesses are snap-fitted to the lower edges of the first cover body and the second cover body.

In order to operate the second cover body conveniently, a hand shank is arranged on the second cover body for pushing or pulling the second cover body.

In order to fold the second cover body entirely under the first cover body as much as possible, the hand shank is at the lower edge of the second cover to prevent the second cover from being blocked.

Further, the first cover body is provided with at least one water injection port, for supplementing food with water during heating to prevent the food from being too dry.

Preferably, a water storage box is arranged around each water injection port for preventing water from leaking out during water injection.

The present disclosure has the beneficial effects:
1. According to the present disclosure, the cover for the microwave oven is divided into two parts, one part can be turned over and stacked on the other part, such that a size of the cover is greatly reduced, and a storage space can be saved when the cover is not in use.
2. The second cover body of the present disclosure can be turned over and retracted under the first cover body. During use, a food state can be checked or food to be heated can be replaced without lifting the entire cover.
3. According to the present disclosure, the diversion recess is provided in a lower portion of each of the two parts of the cover body for storing water or oil flowing down, such that the microwave oven is prevented from being polluted. In addition, the diversion nozzle is provided at each of the two ends of the diversion recess, such that the water or oil can be poured out from two sides without angle adjustment and convenient operation is implemented.
4. According to the present disclosure, the water injection port is provided in the cover, such that water can be supplemented during food heating, and the food is prevented from being dried. Two water injection ports are provided, such that a better anti-drying effect can be achieved.

### BRIEF DESCRIPTION OF THE DRAWINGS

FIG. 1 is a front view of Example 1;

FIG. 2 is a top view of Example 1;

FIG. 3 is a perspective view of a second cover body in a stretched state in Example 1;

FIG. 4 is a perspective view of Example 1 with a lid of a water storage box removed;

FIG. 5 is a perspective view of a second cover body in a retracted state in Example 1;

FIG. 6 is a front view of Example 2;

FIG. 7 is a top view of Example 2;

FIG. 8 is a sectional view along line A-A of FIG. 7;

FIG. 9 is a perspective view of a second cover body in a stretched state in Example 2;

FIG. 10 is a perspective view of Example 2 with a lid of a water storage box removed; and

FIG. 11 is a perspective view of a second cover body in a retracted state in Example 2.

In the figures, 1. second cover body, 2. bolt, 3. hand shank, 4. water storage box, 5. handle, 6. first cover body, 7. vent cover, 8. large hole, 9. small hole, 10. lid, 11. water injection port, 12. first diversion recess, 13. second diversion recess, and 14. diversion nozzle.

### DETAILED DESCRIPTION OF THE EMBODIMENTS

The present disclosure will be described in detail below with reference to accompanying drawings and in conjunction with examples.

### Example 1

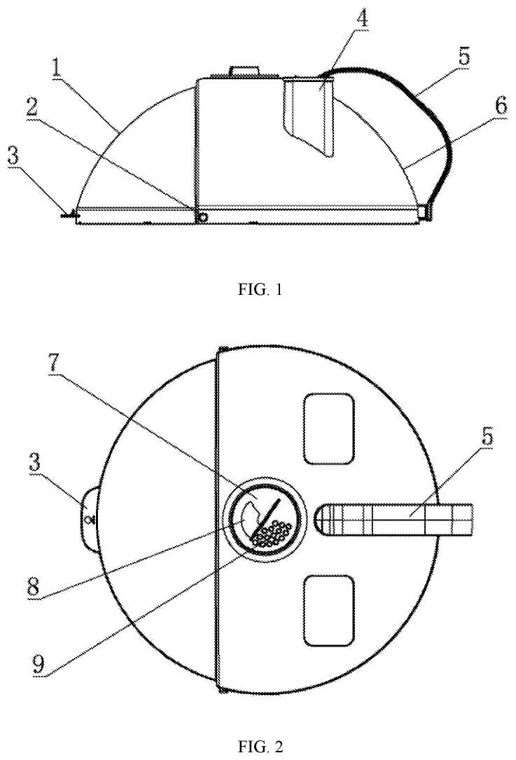

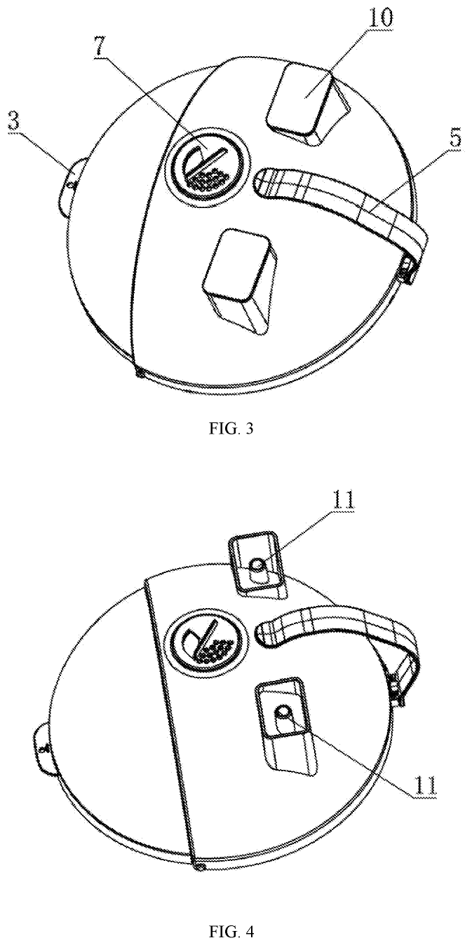

A food cover for a microwave oven, as shown in FIGS. 1-5, includes a cover body, the cover body is divided into a first cover body 6 and a second cover body 1, and the first cover body 6 and the second cover body 1 have cambered surfaces. Edges, on an upper side, of the first cover body and the second cover body that are in a stretched state are referred to as upper edges, and edges on a lower side are referred to as lower edges. Two via holes are provided in a junction of the upper edge and the lower edge of each of the two cover bodies, and the two cover bodies are hinged together by inserting bolts 2 into the via holes. A bending angle and size of the upper edge of the first cover body match a bending angle and size of the upper edge of the second cover body, and a bending angle and size of the lower edge of the first cover body match a bending angle and size of the lower edge of the second cover body. After the second cover body is turned downwards and stretched, the upper edge of the second cover body is under and attached to the first cover body. The lower edge of the second cover body and the lower edge of the first cover body are located in the same plane and a circle is approximately formed. A center of the lower edge of the second cover body is provided with a protruding plate as a hand shank 3 for pushing or pulling the second cover body. A top of the first cover body 6 is provided with a vent hole, and a rotatable vent cover 7 is mounted. The vent cover 7 is provided with a large hole 8 and several small holes 9, such that a ventilation flow can be changed by rotating the vent cover. The first cover body 6 is further provided with two water injection ports 11. The water injection ports are small cylinders protruding from the cover body. When in use, water can be added into food through the water injection ports, such that the food is prevented from being too dry, and the disadvantage of excessive water loss when the food is heated by the microwave oven is overcome. A water storage box 4 is arranged around the water injection port 11 for receiving water flowing out during water injection. A lid 10 is arranged on the water storage box 4 for covering the water injection port when no water is injected. The first cover body 6 is further provided with a handle 5 for the food cover to be held.

### Example 2

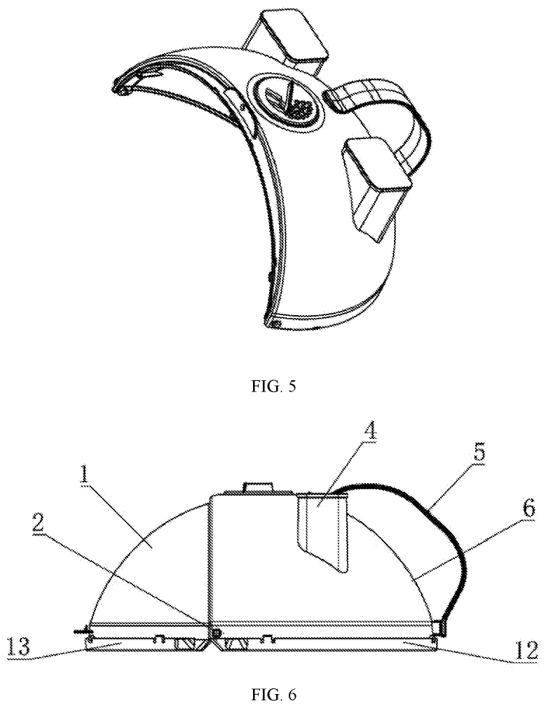

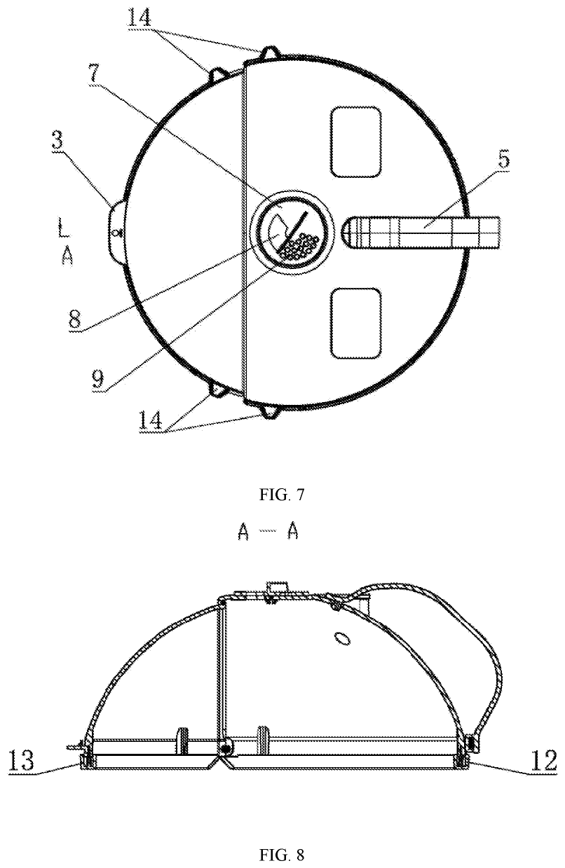

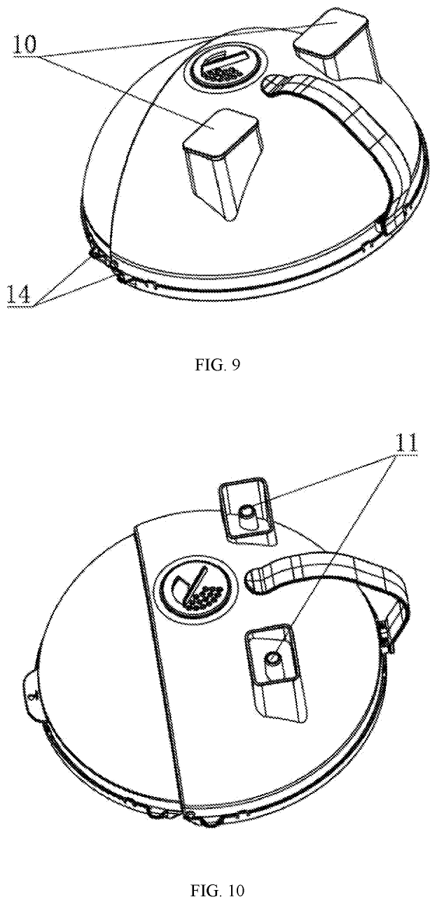

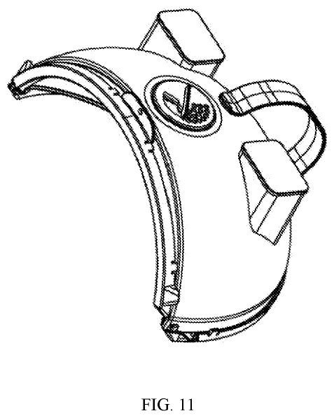

A food cover for a microwave oven is shown in FIGS. 6-11. In this example, a diversion recess is additionally designed on the basis of Example 1 for collecting water or oil flowing down from an inner side of a cover body during heating. In order to match two cover body structures of the example, a matching semi-annular diversion recess is provided in each of lower edges of two cover bodies. A first diversion recess 12 is provided in a lower portion of a first cover body 6, and a second diversion recess 13 is provided in a lower portion of the second cover body 1. The two diversion recesses are snapped on bosses arranged at the lower edges of the covers, so as to be connected to the cover bodies. Two ends of the two diversion recesses are closed, and a diversion nozzle 14 is provided in each of outer sides of the two ends for pouring water or oil out.

When in use, the second cover body is turned downwards to cover food. During use, water can be added to food through the water injection port. When not in use, the second cover body is turned upwards and retracted under the first cover body, such that convenient storage is implemented.

What is claimed is:

1. A food cover for a microwave oven, comprising a cover body and a handle (5) on the cover body, wherein the cover body is provided with a vent hole, the cover body is divided into a first cover body (6) and a second cover body (1), and the second cover body (1) is hinged to the first cover body (6); upper edges, lower edges and surfaces of the first cover body (6) and the second cover body (1) match in shape, such that after the second cover body (1) is turned downwards, the upper edge of the second cover body (1) is attached to the upper edge of the first cover body (6), and the lower edge of the second cover body (1) and the lower edge of the first cover body (6) are located in the same plane; and after the second cover body (1) is turned upwards, the second cover body (1) and the first cover body (6) are stacked.

2. The food cover for a microwave oven according to claim 1, wherein the first cover body (6) and the second cover body (1) have cambered surfaces, and the first cover body (6) and the second cover body (1) that is stretched form a hemisphere.

3. The food cover for a microwave oven according to claim 2, wherein a hinge point of the first cover body (6) and the second cover body (1) is at a junction of the upper edge and the lower edge.

4. The food cover for a microwave oven according to claim 1, wherein each of the lower edges of the first cover body (6) and the second cover body (1) is provided with one diversion recess, two ends of the diversion recess are closed, and a diversion nozzle (14) is provided in each of the diversion recesses.

5. The food cover for a microwave oven according to claim 4, wherein one diversion nozzle (14) is provided at each of outer sides of two ends of the diversion recess of each of the first cover body (6) and the second cover body (1).

6. The food cover for a microwave oven according to claim 4, wherein the diversion recess is a semi-annular recess that matches the lower edges of the first cover body (6) and the second cover body (1) in length, and the diversion recesses are snap-fitted to the lower edges of the first cover body (6) and the second cover body (1).

7. The food cover for a microwave oven according to claim 1, wherein a hand shank (3) is arranged on the second cover body (1) for pushing or pulling the second cover body (1).

8. The food cover for a microwave oven according to claim 7, wherein the hand shank (3) is at the lower edge of the second cover body (1).

9. The food cover for a microwave oven according to claim 1, wherein the first cover body (6) is provided with at least one water injection port (11) for supplementing food with water during heating to prevent the food from being too dry.

10. The food cover for a microwave oven according to claim 9, wherein a water storage box (4) is arranged around each water injection port (11) for preventing water from leaking out during water injection.
